(19) United States
(12) Patent Application Publication
(10) Pub. No.: US 2014/0077623 A1
(43) Pub. Date: Mar. 20, 2014

(54) SPIKE TRAP LOGIC TO PREVENT UNNEEDED INTERRUPTION OF INDUSTRIAL PROCESSES

(71) Applicant: Air Liquide Large Industries US LP, Houston, TX (US)

(72) Inventor: Terence Michael COLLERAN, Acworth, GA (US)

(73) Assignee: Air Liquide Large Industries US LP, Houston, TX (US)

(21) Appl. No.: 13/931,178

(22) Filed: Jun. 28, 2013

Related U.S. Application Data
(60) Provisional application No. 61/702,585, filed on Sep. 18, 2012.

(51) Int. Cl. H02J 4/00

(52) U.S. Cl. CPC H02J 4/00
USPC 307/116

(57) ABSTRACT

Techniques are disclosed for preventing unneeded interruption of industrial processes. Spike trap logic used to delay the occurrence of a trip or interlock when a registered signal exceeds a threshold for a minimum period of time. Doing so prevents trips or interlocks from occurring for transient or intermittent signals, which may be the result of poor sensor readings, poor configuration, or actual, but brief, spikes that should not result in a tripped process or machine. That is, rather than simply tripping—or interlocking—when a trip signal is initially observed, the spike trap logic introduces a delay between when a trip signal is received and when an interlock or trip event actually happens. If the signal remains high for delay period, a trip occurs. Otherwise, the trip signal is considered an intermittent or transient spike and does not result in a trip.

### CROSS REFERENCE TO RELATED APPLICATIONS

This application claims benefit of U.S. Provisional Patent Application Ser. No. 61/702,585 filed Sep. 18, 2012, which is incorporated herein by reference in its entirety.

### BACKGROUND

Generally, a pipeline system provides a continuous pipe conduit that includes a variety of components and equipment, e.g., valves, compressor stations, communications systems, and meters. A pipeline may be used to transport liquid or gaseous materials from one point to another, usually from one point (or points) of production or processing to another, or to points of use. For example, an air separation unit (ASU) may be used to separate atmospheric air into gaseous components (e.g., oxygen gas (O₂), nitrogen gas (N₂), Argon gas (Ar), etc.) introduced into a pipeline. Similarly, hydrogen gas (H₂) can be produced using a steam methane reformer (SMR). At stations along the pipeline, compressors maintain the pressure of the material in the pipeline as it is transported from one site to another. Similarly, for a liquid bearing pipeline, pumps may be used to introduce and maintain pressure for a liquid substance transported by the pipeline.

A variety of devices are used to protect the components of an ASU, SMR, pipeline, or other industrial process, machine or system to prevent one malfunctioning component from being damaged or to prevent a dangerous operational state from occurring (or continuing). For example, a programmable logic controller (PLC) or distributed control system (DCS) may be configured to interrupt or shutdown an ASU when sensor readings deviate from a defined operating range, e.g., when a temperature exceeds a threshold or a vibration monitor on a centrifuge exceeds a maximum. An ASU will typically have sensors to evaluate temperatures, pressures vibration at a large number of points. While these systems can prevent an ASU from operating in an unsafe state, PLCs frequently trip—or interlock—due to a transient spike in operating conditions (e.g., a temperature sensor briefly spikes). The cause of such a spike can be an actual change in operating conditions (i.e., the temperature may have change rapidly in a transient manner), but can also be the result of inaccurate sensor readings, sensor quality, wiring, installation errors, and a variety of other reasons.

Further, it is often difficult to determine what sensor or signal actually caused an interlock or trip event. For example, a PLC may include a ladder configured to latch the first signal it reads as high (or low) following a trip event. However, doing so often fails to identify the actual signal that that initiated the interlock. In such case, if an operator replaces or repairs one component of the system, based on the latched signal, then the system may re-trip when returned to operation. Due to the unreliable trip signals on a PLC, system operators sometimes chose to replace everything related to a given PLC following a trip rather than focusing on the signal indicated as causing the trip. For example, for an ASU, an operator may replace a centrifuge, wiring, sensor, transmitter and PLC following a trip event related to a vibration sensor, even though much of the equipment is in working condition.

Further, software tools used to manage an industrial process may provide inaccurate (or at least incomplete) information from a PLC. For example, a software management and trending tool may receive a signal from a PLC at intervals slower than the frequency at which a PLC monitors a device. Doing so can result in a trend or graph of sensor data that registers no problem, even though an interlock occurs. For example, a spiking temperature can trip an interlock in-between temperature values being reported to the management tool.

### SUMMARY

Embodiments of the invention provide techniques for managing an industrial process or system. One embodiment of the invention includes a method for managing an interlock system in an industrial process. This method may generally include configuring spike trap logic on the interlock system with a specified delay period and configuring a trip state value for first monitored process. While monitoring the first monitored process, if the trip state value indicates the first monitored process is in a trip state, then a trap count representing a time period of how long the first monitored process has been in a trip state is incremented. Further, if the trip state value remains in the trip state for the specified delay period, then the spike trap logic sends an interlock signal. The interlock signal interrupts the industrial process from continuing. In a particular embodiment, if it is determined that, prior to being in the trip state for the specified delay period, the first monitored process is no longer in a trip state, then an event time associated with the trap state is restate. The event time measures how long the first monitored process is in the trip state.

Other embodiments of the invention include, without limitation, a computer-readable storage medium including instructions that, when executed by a processing unit, cause the processing unit to implement aspects of the approach described herein as well as a system that includes different elements configured to implement aspects of the approach described herein.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 illustrates an example of a monitored pipeline and an operations control center, according to one embodiment.

FIG. 2 illustrates a simplified example of a programmable logic controller (PLC) configured with spike trap logic, according to one embodiment.

FIG. 3A-3C illustrates examples of inputs and outputs for a PLC configured with spike trap logic, according to one embodiment.

FIG. 4 illustrates a method for spike trap logic on a PLC to prevent unneeded interruption of industrial processes, according to one embodiment of the invention.

### DESCRIPTION OF PREFERRED EMBODIMENTS

Embodiments of the invention provide techniques for preventing unneeded interruption of industrial processes. In one embodiment, a programmable logic control (PLC) is configured with spike trap logic used to delay the occurrence of a trip or interlock when a registered signal exceeds a threshold for a minimum period of time. Doing so prevents trips or interlocks from occurring for transient or intermittent signals, which may be the result of poor sensor readings, poor configuration, or actual, but brief, spikes that should not result in a tripped process or machine. That is, rather than simply tripping—or interlocking—when a trip signal is initially observed, the spike trap logic introduces a delay between when a trip signal is received and when an interlock or trip event actually happens. If the signal remains high for delay period, a trip occurs. Otherwise, the trip signal is considered an intermittent or transient spike and does not result in a trip.

In one embodiment, the spike signal is still recorded as a trapped spike event, which may be useful for trending and forecasting the process being monitored by the PLC. For example, the PLC may send messages to an HMI (human machine interface) at a control center to provide plant operators with information indicating that a trip signal was observed, but did not last long enough to result in an actual interlock or trip. That is, the operator may learn that the spike trap logic prevented a PLC from tripping a process or machine. The message may indicate which signal was observed that would have resulted in a trip if the spike trap logic was not in place. That is, the trap signals allow the PLC to provide additional diagnostic information to the HMI. Further, the spike trap logic can be configured to estimate a costs savings resulting form the avoidance of a trip do to a transient or “spiked” trip signal. Further still, if a trip does occur, the spike trap logic also correctly identifies what signal remained high for the delay period. Doing so allows an operator to address elements of the system that resulted in the trip signal that remained high for the delay period.

Embodiments of the invention are described herein using a production facility configured to produce material (e.g., industrial gases) delivered by a pipeline as a reference example of an industrial process with systems monitored by spike trap logic and PLC controllers. Other complex industrial systems and processes use a similar approach. For example, PLC systems at a petroleum refinery (at one end of a pipeline) may be monitored from a central control center data collected from the PLC devices at the refinery. Similarly, chemical production or processing facilities, steel mills, manufacturing plants, assembly lines, or other industrial process with PLC devices configured to trip or interlock when to prevent a malfunctioning component from being damaged or to prevent a dangerous operational state from occurring (or continuing) may benefit from the spike trap logic described herein.

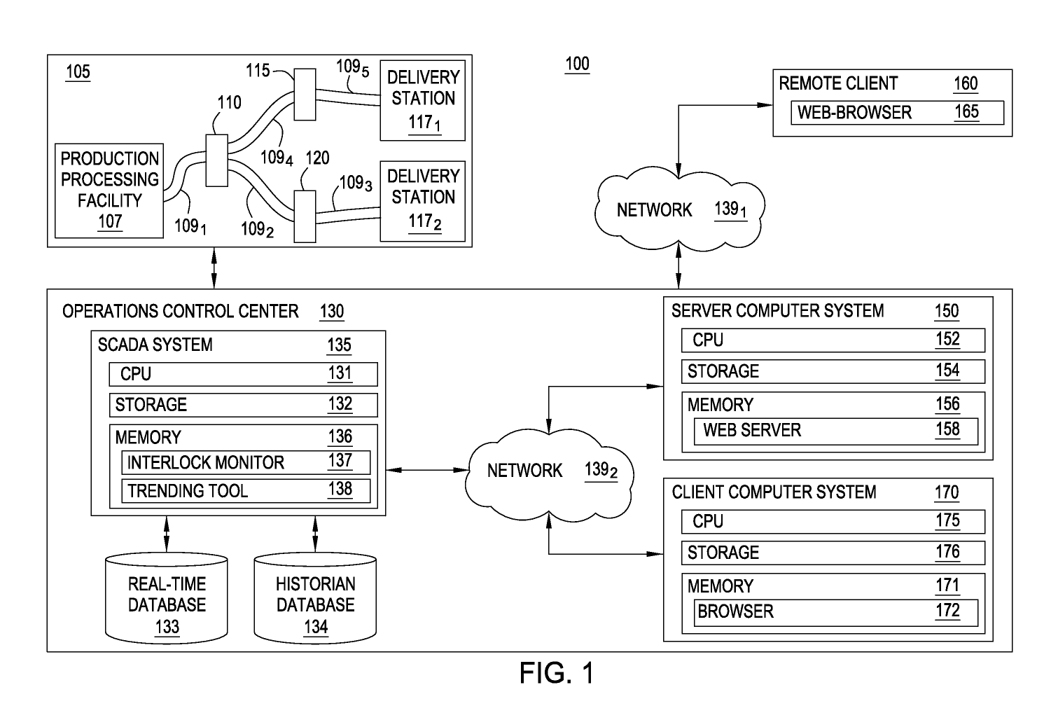

FIG. 1 is an illustration of a system 100 that includes a monitored pipeline 105 and an operations control center 130, according to one embodiment of the invention. As shown, monitored pipeline network 105 includes a production/processing facility 107 and delivery station 117₁₋₂. Facility 107 may represent, for example, a molecular gas generation plant that includes one or more air separation units (ASUs) used to purify gaseous substances from the ambient atmosphere. The resulting product is delivered to stations 117₁₋₂ over a pressurized gas pipeline. Illustratively, pipeline 105 includes pipeline segments 109₁₋₅. Pipeline segments 109₁, 109₂, and 109₃, provide a path from facility 107 to delivery station 117₂ and pipeline segments 109₁, 109₄ and 109₅ provide a path from facility 107 to delivery station 117₁. Additionally, pipeline 105 includes compressor stations 110, 115, and 120 used to maintain the pressure of gaseous substances transported over pipeline 105.

The ASUs at production/processing facility 107 and compressor stations 110, 115, and 120 may include sensor equipment used to monitor aspects of the operational state of the pipeline 105. For example, a variety of programmable logic controllers (PLCs) and distributed control systems (DCSs) may send information to the operations control center. Further, in one embodiment, the PLCs and DCSs may each include spike trap logic used to control when an interlock or trip event used to safeguard the product, process, or equipment monitored by the PLC. For a pressurized gas pipeline, for example, a wide variety of field devices and parameters may be monitored including, for example, inlet gas pressure, outlet gas pressure, gas temperature, cooling liquid temperature, flow rates, and power consumption, among others. Similarly, the operational state of various field devices, air separation units, and equipment at production facility 107 and delivery station 117 may be monitored by sensor equipment. Of course, for other industrial networks and systems, the sensors and monitoring equipment may be selected to suit the needs of a particular case.

In one embodiment, the results of the monitoring equipment are transmitted to the pipeline operations control center 130. The pipeline operation control center 130 may employ a number of computer systems running application programs used to coordinate, monitor, and control the operations of pipeline 105. Illustratively, pipeline operations control center 130 includes a SCADA (Supervisory Control and Data Acquisition) system 135, a server system 150, a real-time database 133 and a historian database 134, and a client system 170, each communicating over a network 139₂. Additionally, a remote client 160 communicates over network 139₁ (e.g., the Internet) with the computer systems of the operations control center 130. For example, a user may interact with a web-browser 165 to access SCADA data over the web server 158. The computer systems 135, 133, 134, 150, 160 and 170 are included to be representative of existing computer systems, e.g., desktop computers, server computers, laptop computers, tablet computers and the like. However, embodiments of the invention are not limited to any particular computing system, application, device, architecture or network, and instead, may be adapted to take advantage of new computing systems and platforms as they become available. Additionally, one skilled in the art will recognize that the illustrations of computer systems 135, 133, 134, 150, 160 and 170 are simplified to highlight aspects of the present invention and that computing systems and networks typically include a variety of components not shown in FIG. 1.

As shown, SCADA system 135 includes a CPU 131, storage 132 and a memory 136. Similarly, server system 150 includes a CPU 152, storage 154, and a memory 156 and client system 170 includes a CPU 175, storage 176, and memory 171. CPUs 131, 152, and 175 are included to be representative of a single CPU, multiple CPUs, a single CPU having multiple processing cores, and the like. Memory 136, 156, and 171 may be a random access memory, e.g., DRAM. While the memory 136, 156, and 171 is shown as a single entity, it should be understood that the memory 136, 156, and 171 may comprise a plurality of modules, and that the memory 136, 156, and 171 may exist at multiple levels, from high speed registers and caches to lower speed but larger DRAM chips. Storage 132, 154, and 176 may be hard disk drive storage devices. Storage 132, 154, and 176 may also be a combination of fixed and/or removable storage devices, such as fixed disc drives, floppy disc drives, tape drives, removable memory cards, or optical storage, etc.

As shown, the memory 136 of the SCADA system 135 includes an interlock monitor 137 and a trending tool 128 138. SCADA system 135 centralizes process data and allows remote monitoring and control of pipeline 105. Illustratively, the SCADA 135 system is configured to gather data in real-time from remote locations in order to control equipment and monitor conditions in pipeline 105. The monitored data may be stored in real-time database 133. The real-time database 133 is generally used to store the last known value for each element of element or component of an industrial system (e.g., pipeline 105) monitored using system 100. That is, the real-time database 133 may store data values each representing a monitored parameter of pipeline 105 and the current operational value of that parameter. The data may be written into real-time database 133 periodically, where values are updated at regular intervals, or exception based, where a new values are written into real-time database 133 only when the monitored value changes more than a predetermined value. SCADA system 135 may include both hardware and software components. The hardware gathers and feeds data into SCADA system 135, which processes this data and presents it to a user on client system 170. In one embodiment, a historian database 134 may be configured to retrieve (or receive) the values for monitored parameters from real-time database 133. Thus, the historian database 134 provides an archive of values from the real-time database 133.

In one embodiment, the interlock monitor 137 receives data from the PLCs monitoring the industrial process (e.g., the production/processing facility 107). For example, interlock monitor 137 may receive messages indicating when trap or trip events have occurred. Note, for convenience, a “trap event” generally refers to a signal that “goes high” while being monitored by a PLC, but does not result in a trip event because it does not continue for a minimum delay period required by the spike trap logic. And a “trip event” generally refers to a signal that remains high for the delay period, after which the system “trips.” That is, the spike trap logic “traps” a spike signal for the delay period. If such a signal remains “high” for the delay period, then a “trip” —or interlock—occurs shutting down the industrial machine, process, or system.

Trending tool 138 may also use information from the PLCs to generate trends related to system behavior. For example, PLCs monitoring the pressure of the pipeline 105 or temperature of the ASUs in the production facility 107, over time, may be used to create trends or forecasts. Doing so allows an operator to predict when a given system may become critical and initiate some form of repair or other corrective action. The browser 172 may be used to present views of process data captured by the interlock monitor 137 and trending tool 138. Of course, the appearance and behavior of how interlock and trend information is presented to an operator may be tailored to suit the needs of an individual case. Further, although real-time database 133, historian system 134, SCADA system 135, server system 150, and client system 170, are shown as separate components, one of ordinary skill in the art will recognize that these components may be applications running on a single computer system, or on multiple computer systems, and further, that these components may be configured in a variety of ways.

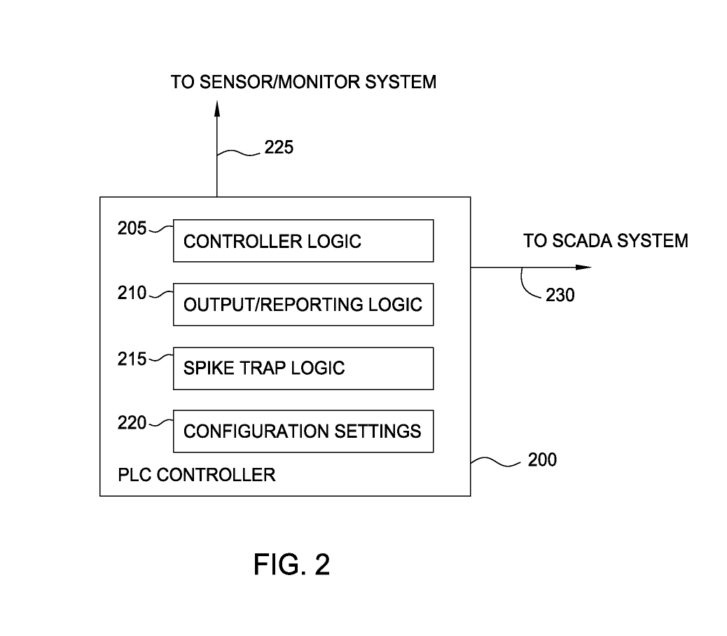

FIG. 2 illustrates a simplified example of a programmable logic controller (PLC) 200 configured with spike trap logic 215, according to one embodiment. As shown, the PLC 200 includes controller logic 205, output/reporting logic 210, spike trap logic 215, and configuration settings 220. The controller logic 205 generally corresponds to logic (e.g., an ASIC or FPGA) used by the PLC 200 to control an industrial system or process. For example, PLC 200 may be used to control a temperature for a component in an ASU. In such a case, the PLC 200 may have a set-point temperature (specified in configuration settings 220) for the ASU. The control logic 205 may start or stop processes to keep the temperature at (or near) the set point. To do so, PLC 200 includes a connection 225 to sensors on the monitored equipment configured which send signals to the PLC 200. The control logic 205 receives information from the sensors to identify a current temperature of the ASU component as well as send signals used to increase (or decrease) the temperature of the ASU component. Of course, the controller logic 205 may be tailored as needed for the particular process, system, or machine being monitored or controlled by the

PLC 200. The control logic 205 may also include a trip or interlock logic used to prevent a dangerous operational state from occurring (or continuing). Again using temperature as an example, the configuration settings 220 may specify a maximum allowed temperature for any number of the sensors reporting temperature to the PLC 200 over connection 225. If a temperature exceeds the maximum, the trip logic is configured to send a trip signal to shut down or otherwise interrupt an industrial process, machine or system. Other examples include trip logic setting a threshold for pressure, flow rates, vibration, electrical consumption, etc. As noted, typically trip or interlock condition stops the machine or process when a configured alarm threshold is passed.

In addition, the controller logic 205 and output/reporting logic 210 may include first-out logic used to send information about a trip signal to SCADA system over connection 230. The first-out logic may provide a logical “OR” configuration within the PLC 200 that includes a latch function to lock onto the first trip (or interlock) signal attached logically to the “OR” configuration that occurs within the particular scan cycle when a trip signal occurs. More generally, the output/reporting logic 210 may be configured to send messages to the SCADA system over connection 230. For example, the PLC may periodically send a current temperature for a component of an ASU to the SCADA system. Note, the frequency at which such sampling occurs may be less than a frequency of the controller logic 205. That is, output/reporting logic 215 does not necessarily send every value observed by the controller logic 205.

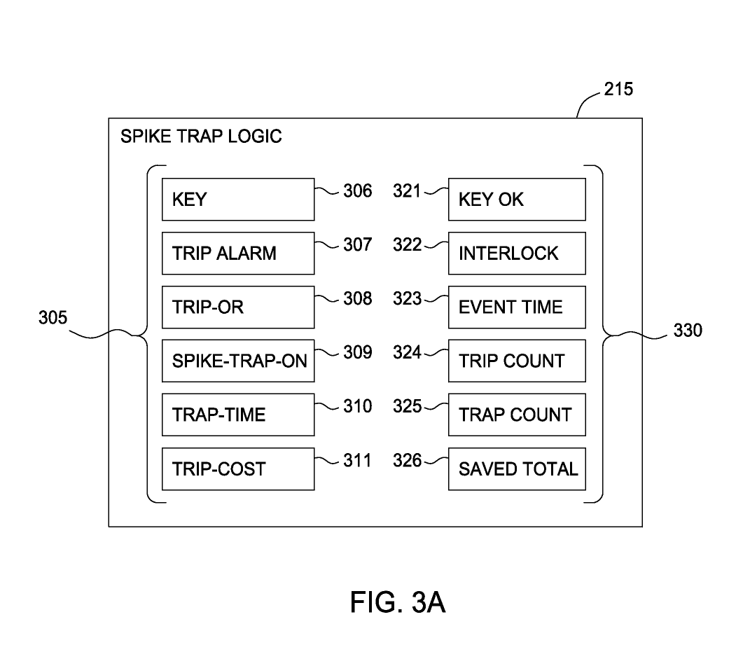

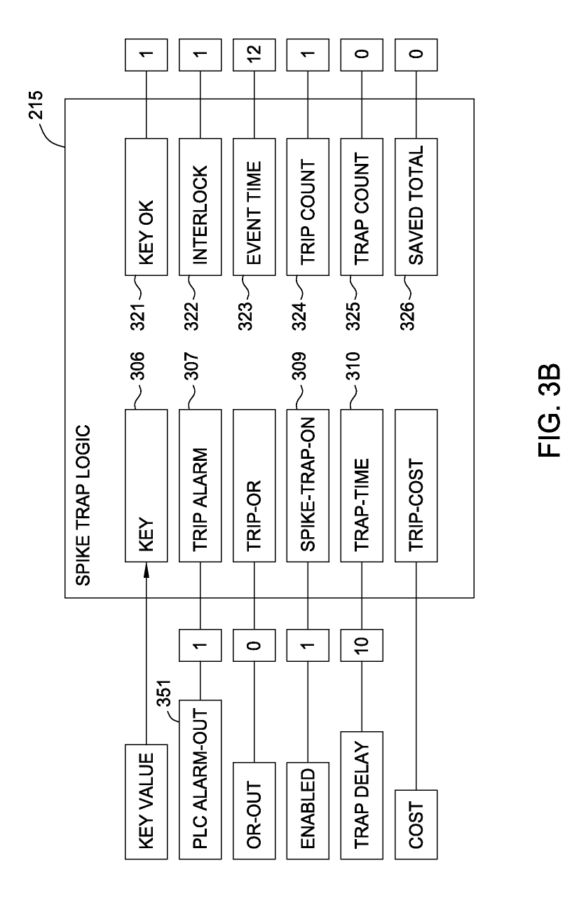

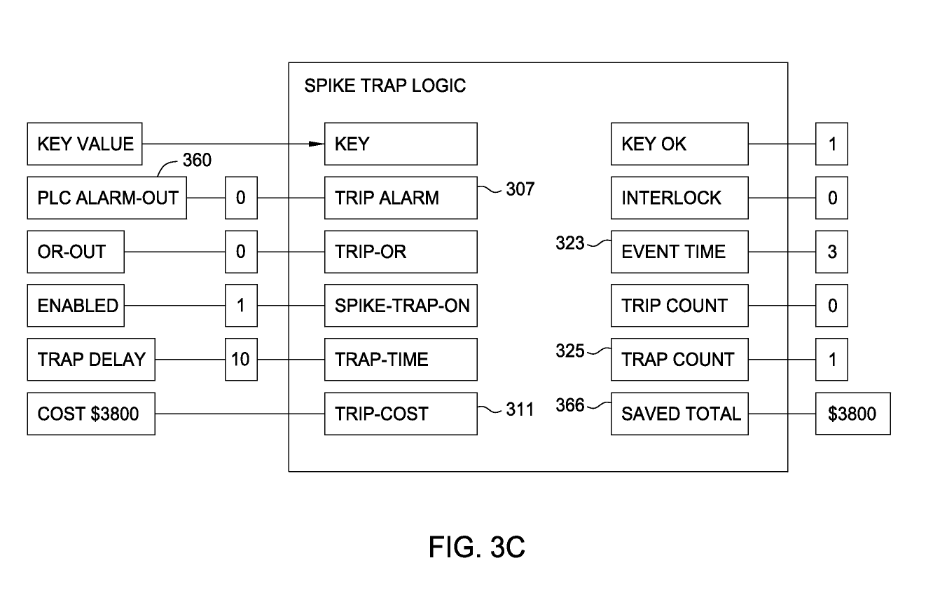

As mentioned, the spike trap logic 215 corresponds to logic (e.g., an ASIC or FPGA) used by the PLC 200 to trap intermittent trip signals observed by the controller logic 205 that would normally result in a trip or interlock event. The spike trap logic generally traps a trip signal for a delay period (as specified in configuration settings 220). Doing so prevents an intermittent, transient, or false-positive trip signal from interrupting an industrial process, machine, or system. FIGS. 3A-3C show an example set of components of spike trap logic 215.

More specifically, FIG. 3A illustrates examples of inputs and outputs for spike trap logic 215, according to one embodiment. As shown, the spike trap logic 215 includes a collection of inputs 305 and outputs 310. The inputs include a key setting 306, a trip alarm state 307, a trip_or signal 308, a spike_trap_on setting 309, a trap_time setting 310, and a trip_cost setting 311. And the outputs 320 include a key_ok signal 321, an interlock signal 322, an event time signal 323, a trip count 324, a trap count 325, and a saved total 326.

The key setting 306 provides an input for use as a software license to enable the spike trap logic functions. For example, the key setting 306 may be a numeric string entered by an operator that needs to mach a corresponding numeric value stored by the spike trap logic 215. If the numeric strings match, then the key_ok signal 321 is set to “1” and the spike trap logic is enabled. If the numeric strings do not match, or is not entered, then the key_ok signal 321 remains “0.” In such a case, the spike trap logic 215 may act as a pass-through and not trap any trip signals.

The trip alarm 307 provides an input for a single interlock parameter. That is, for a trip signal tied to a single sensor, the trip alarm 307 input signals the occurrence of a trip event. The trip alarm 307 receives a trip signal from the spike trap logic 215. When a trip signal is received the output on interlock signal 322 is set to 1. However, when enabled, the spike trap logic 215 traps the trip alarm signal for a predefined delay period before allowing an interlock or trip to occur. Otherwise, if operating in a pass through mode, a signal on the trip alarm 307 is forwarded by the spike trap logic 215, resulting in an immediate trip event. Similarly, the trip_or signal 308 receives a signal from generated from multiple interlock input signals. That is, the trip_or signal 308 receives a trip signal resulting from any source within the control system, e.g., alarms, inputs, declared variables from process or machinery configuration. This signal may be used in conjunction with, and logically connected to the output of, an OR block or other logical expression in an OR Configuration. The trip_or signal allows multiple trip signals, any one of which going high would trigger a trip or interlock, to provide a single input to the spike trap logic. As with the trip alarm signal 307 (indicating an observed trip event), the spike trap logic 215 may trap a trip signal received over the trip_or signal 308 for a predefined delay period before allowing an interlock or trip to occur. If a trip signal received on the trip_or signal 308 remains high for the predefined delay period, then the output on interlock signal 322 is set to 1, resulting in an actual trip.

The spike_trap_on setting 309 provides an input for a Boolean parameter from any source within PLC to enable the spike trap logic 215 and trap any trip signals observed over the trip alarm signal 307 or the trip_or signal 308. This signal is set to 1 when spike identification and trapping is desired. If the spike_trap_on setting 309 is “0” (not running), then the spike trap logic 205 operates in a pass through mode, allowing an allowing a interlock condition to instantly trip or otherwise interrupt an machine, process, or system monitored by the PLC.

The trap_time setting 310 provides a numeric input representing the amount of time, in seconds, which must pass before the output interlock 222 INTERLOCK” transitions from “0” to “1” in order to create an interlock or trip. Note, in one embodiment, if not provided as an input, then a default trap_time setting 310, e.g., 3 seconds, may be used. Also note, the trap_time setting 310 may be used for either a trip signal received over trip alarm signal 307 or a trip_or signal 308.

The trip_cost setting 311 provides a numeric input representing an estimated monetary value due to intermittent or transient spike which resulted in a trip event or interlock. That is, the trip_cost setting 311 represents a cost that would be incurred as a result of the system, process, or machine being interrupted by a trip event, if the spike trap logic 215 not trapped an intermittent or transient trip signal.

The event time signal 323 is output when the trip alarm signal 307 or the trip_or signal 308 transitions from “0” to “1”, indicating a trip event has been intercepted by the spike trap logic 205. The event time signal 323 outputs how long the trip condition has remained active, e.g., in seconds. The event time signal 323 stops counting and captures the elapsed time if either trip signal ends, i.e., if the trip alarm signal 307 or the trip_or signal 308 transitions from “1” to “0” prior to the delay period expiring, as set by the trap_time setting 310. That is, the event time signal 323 outputs how long a trip signal has been occurring (or had occurred). If the trip signal does not remain “high” for the delay period, then the trip event is considered an intermittent or transient spike that should not result in an actual trip interrupting a system, process or machine. That is, the spike trap logic 215 may determine that an interlock condition does not exist, but instead, the source of the interlock condition is from a spike, and that the system can continue without interruption. In one embodiment, the occurrence, as well as the amount of time, a spike trip event occurs may be sent to the SCADA system, allowing on operator to identify systems that, while not actually causing a trip event, need to be evaluated.

Otherwise, if the trip alarm signal 307 or the trip_or signal 308 transitions from “1” to “0” after the of period specified by the trap time settings 310, then the spike trap logic 215 determines that an actual trip or interlock condition has occurred and outputs a signal on interlock signal 322. Reporting the time a signal remains high, even when it exceeds the delay period, may be useful to determine the average time a trip signal for a given system tends to remain high, allowing an operator to fine tune the trap_time setting 310.

The trip count 324 provides an output incremented for each trip signal observed by the spike trap logic that exceeds the trap_time settings 310. That is, the trip count 324 counts the number of actual trips or interlocks that have occurred. The spike trap logic may also include a reset all function used to reset the trip count 324 and trap count 325.

The trap count 325 provides an output incremented each time an intermittent or transient trip signal is observed. In one embodiment, the trap count 325 is incremented when both a trip signal occurs (i.e., the trip alarm signal 307 or the trip_or signal 308 transitions from “0” to “1”) and when that same trip signal ends, (i.e., the trip alarm signal 307 or the trip_or signal 308 transitions back from “1” to “0”) in a period less than the trap_time setting 310. That is, the trap count 325 counts the number of spike trip events trapped by the spike trap logic 315. The saved total 326 output may be calculated as the product of the trip_cost 311 and the trap count 325. Doing so allows an operator to track, over time, an estimated cost amount that would have been lost, due to spike trips, if the spike trap logic 314 was not enabled. In addition, the trip count 324, trap count 325, and saved total 326 may be periodically provided to the operations control center, and stored. Doing so allows these metrics be trended on an HMI used to monitor and control the industrial process.

FIGS. 3B-3C illustrate example settings for inputs and outputs for a PLC configured with spike trap logic 215, according to one embodiment. In FIG. 3B, a simulated alarm has been forced at input alarm_out 351 of “1”. This signal is supplied to the trip alarm signal 307. A value of 10 seconds provides delay period for the trap_time setting 310. Again, this value provides a configured time for differentiating between a spike or transient trip and an actual interlock condition. A value of “1” is input to the spike_trap_on setting 309, enabling the spike trap logic 215. Also, assume that the key value input to key 308 is correct, resulting in the key OK signal output as “1.” Following a 10 second delay after the trip alarm signal 307 was set to “1,” the interlock signal 322 outputs a “1,” indicating a true interlock event. At this point, the spike trap logic 215 has evaluated spike event (represented by alarm_out signal 351, and determined that the machine, process, or system has crossed a configured alarm threshold and is not a momentary spike condition. The output trip count has increased by “1” to capture the occurrence of an actual interlock condition. At the same time, the outputs trap count 325 and saved total 326 remain “0,” as indicated for an EVENT determined as an interlock condition and not a momentary spike.

In contrast, FIG. 3B illustrates an example of a spike trip event, according to one embodiment. For this example, assume an alarm signal was forced at PLC alarm_out 360 (i.e., set to “1”) for three seconds and then returned to a normal condition (i.e., returned to “0”). That is, a momentary spike has been simulated. In this example, the trap_time setting 310 is 10 seconds, so the three second spike provided over alarm_out 360 is insufficient to be considered a true trip event or interlock. As a result, the trap count 324 is incremented to “1.” Because the spike trap logic 215 “trapped” the transient trip signal, the process under protection may continue without interrupt. Further, the output event time 323 is updated to 3, showing the duration of the trapped event (and showing that it is less than the minimum delay period). The saved total 326 has increased by the cost specified by trip cost 311 to indicate the amount of money that an interlock or trip condition would have cost had the spike trap logic 215 not intervened and continued running the system, process, or machine under protection. In one embodiment, the event time 323 may be passed to a previous time element before being reset, allowing the previous event length to remain available and be evaluated with the time of the current event.

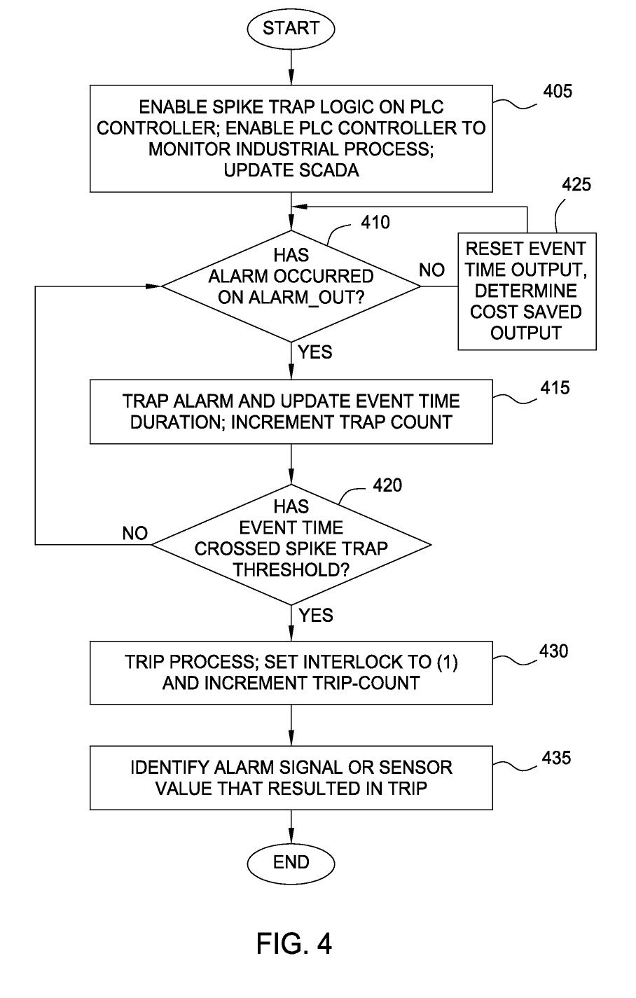

FIG. 4 illustrates a method 400 for spike trap logic 215 on a PLC to prevent unneeded interruption of industrial processes, according to one embodiment of the invention. As shown, the method 400 begins at step 405, where spike trap logic 215 is enabled on a PLC controller. Once enabled, the PLC also begins monitoring an industrial process, system, or machine. Further, the PLC may also begin sending observed data to a SCADA system. At step 410, the spike trap logic 215 determines whether a trip event has occurred, i.e., whether the trip alarm signal 307 or the trip_or signal 308 transitions from “0” to “1.” If so, at step 415 the spike trap logic 215 increments the event time, indicating how long a current trip event has been observed. At step 420, the spike trap logic 215 determines whether the currently trapped signal has been observed for the minimum delay period. If not, the method returns to step 410 to evaluate whether the trip signal remains “high,” indicating that the current trip event remains ongoing. If the signal is no longer “high,” i.e., the trip alarm signal 307 or the trip_or signal 308 has transitioned from “0” to “1,” then at step 425, the current trip is determined to be a transient or spiked trip that does not warrant interrupting the industrial process, machine or system under protection of the spike trap logic 215. As a result, at step 425 the event time is recorded and reset, and the cost savings of the trapped trip event is calculated and output as the saved total, in the manner discussed above.

Otherwise, the spike trap logic 215 continues looping through steps 410 and 415 until reaching the spike trap delay time threshold. If a current trip event remains active (i.e., if the trip alarm signal 307 or the trip_or signal 308 remains “1”) for the configured spike trap threshold, then at step 430, the spike trap logic 215 determines that a true trip event has occurred and that the industrial process, machine or system under protection should be shut down or otherwise interrupted. Accordingly, the spike trap logic 215 sets the interlock signal 322 to “1” and increments the trip count. At step 435, the spike trap logic 215 identifies the alarm signal or sensor value that resulted in the trip and outputs this information to the SCADA system.

Advantageously, embodiments described above provide techniques for preventing unneeded interruption of industrial processes. In one embodiment, a programmable logic control (PLC) is configured with spike trap logic used to delay the occurrence of a trip or interlock when a registered signal exceeds a threshold for a minimum period of time. Doing so prevents trips or interlocks from occurring for transient or intermittent signals, which may be the result of poor sensor readings, poor configuration, or actual, but brief, spikes that should not result in a tripped process or machine. That is, rather than simply tripping—or interlocking—when a trip signal is initially observed, the spike trap logic introduces a delay between when a trip signal is received and when an interlock or trip event actually happens. If the signal remains high for delay period, a trip occurs. Otherwise, the trip signal is considered an intermittent or transient spike and does not result in a trip.

In the foregoing, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified a FIG. 1 is an illustration of a monitored pipeline and an operations control center, according to one embodiment of the invention;

It will be understood, however, that many additional changes in the details, materials, steps, and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

What is claimed is:

1. A method for managing an interlock system in an industrial process, the method comprising:
configuring spike trap logic on the interlock system with a specified delay period;
configuring a trip state value for first monitored process; and
while monitoring the first monitored process:
upon determining the trip state value indicates the first monitored process is in a trip state, incrementing a trap count representing a time period of how long the first monitored process has been in a trip state, and
upon determining the trip state value has been in the trip state for the specified delay period, sending, by the spike trap logic, an interlock signal.

2. The method of claim 1, wherein the interlock signal interrupts the industrial process from continuing.

3. The method of claim 1, further comprising, while monitoring the first monitored process:
upon determining that, prior to being in the trip state for the specified delay period, the first monitored process is no longer in a trip state, resetting an event time associated with the trap state, wherein the event time measures how long the first monitored process is in the trip state.

4. The method of claim 1, further comprising, while monitoring the first monitored process:
upon determining that, prior to being in the trip state for the specified delay period, the first monitored process is no longer in a trip state, determining an estimated cost value from preventing an interlock event due to a transient trip state for the first monitored process.

5. The method of claim 1, wherein the first monitored process comprises one of a plurality of process monitored by the spike trap logic, and wherein each of the plurality of processes has an associated delay period and trip state value.

6. The method of claim 5, further comprising, upon determining the trip state value for at least one of the monitored process has been in the trip state for the specified delay period, transmitting an indication of which of the monitored process remained in a trip state for the specified delay period along with the interlock signal.

7. The method of claim 1, wherein the trip state value corresponds to a temperature, a pressure, a flow rate, a vibration state, or an electrical consumption associated with the first monitored process.

8. The method of claim 1, wherein the interlock system comprises a programmable logic controller configured to manage the industrial process.

9. A computer-readable storage medium containing instructions, which, when executed on a processor, perform an operation for managing an interlock system in an industrial process, the operation comprising:
configuring spike trap logic on the interlock system with a specified delay period;
configuring a trip state value for first monitored process; and
while monitoring the first monitored process:
upon determining the trip state value indicates the first monitored process is in a trip state, incrementing a trap count representing a time period of how long the first monitored process has been in a trip state, and
upon determining the trip state value has been in the trip state for the specified delay period, sending, by the spike trap logic, an interlock signal.

10. The computer-readable storage medium of claim 9, wherein the interlock signal interrupts the industrial process from continuing.

11. The computer-readable storage medium of claim 9, wherein the operation further comprises, while monitoring the first monitored process:
upon determining that, prior to being in the trip state for the specified delay period, the first monitored process is no longer in a trip state, resetting an event time associated with the trap state, wherein the event time measures how long the first monitored process is in the trip state.

12. The computer-readable storage medium of claim 9, wherein the operation further comprises, while monitoring the first monitored process:
upon determining that, prior to being in the trip state for the specified delay period, the first monitored process is no longer in a trip state, determining an estimated cost value from preventing an interlock event due to a transient trip state for the first monitored process.

13. The computer-readable storage medium of claim 9, wherein the first monitored process comprises one of a plurality of process monitored by the spike trap logic, and wherein each of the plurality of processes has an associated delay period and trip state value.

14. The computer-readable storage medium of claim 13, wherein the operation further comprises, upon determining the trip state value for at least one of the monitored process has been in the trip state for the specified delay period, transmitting an indication of which of the monitored process remained in a trip state for the specified delay period along with the interlock signal.

15. The computer-readable storage medium of claim 9, wherein trip state value corresponds to a temperature, a pressure, a flow rate, a vibration state, or an electrical consumption associated with the first monitored process.

16. The computer-readable storage medium of claim 9, wherein the interlock system comprises a programmable logic controller configured to manage the industrial process.

17. A system, comprising:
a processor; and
a memory storing a dynamic data server application, which when executed on a processor is configured to perform an operation for providing a view of process data of a monitored industrial system, the operation comprising:
configuring spike trap logic on the interlock system with a specified delay period,
configuring a trip state value for first monitored process, and while monitoring the first monitored process:
upon determining the trip state value indicates the first monitored process is in a trip state, incrementing a trap count representing a time period of how long the first monitored process has been in a trip state; and
upon determining the trip state value has been in the trip state for the specified delay period, sending, by the spike trap logic, an interlock signal.

18. The system of claim 17, wherein the interlock signal interrupts the industrial process from continuing.

19. The system of claim 17, wherein the operation further comprises, while monitoring the first monitored process:
upon determining that, prior to being in the trip state for the specified delay period, the first monitored process is no longer in a trip state, resetting an event time associated with the trap state, wherein the event time measures how long the first monitored process is in the trip state.

20. The system medium of claim 17, wherein the operation further comprises, while monitoring the first monitored process:
upon determining that, prior to being in the trip state for the specified delay period, the first monitored process is no longer in a trip state, determining an estimated cost value from preventing an interlock event due to a transient trip state for the first monitored process.

21. The system of claim 17, wherein the first monitored process comprises one of a plurality of process monitored by the spike trap logic, and wherein each of the plurality of processes has an associated delay period and trip state value.

22. The system of claim 21, wherein the operation further comprises, upon determining the trip state value for at least one of the monitored process has been in the trip state for the specified delay period, transmitting an indication of which of the monitored process remained in a trip state for the specified delay period along with the interlock signal.

23. The system of claim 17, wherein trip state value corresponds to a temperature, a pressure, a flow rate, a vibration state, or an electrical consumption associated with the first monitored process.

24. The system of claim 17, wherein the interlock system comprises a programmable logic controller configured to manage the industrial process.
